(19) United States
(12) Patent Application Publication
(10) Pub. No.: US 2005/0181848 A1
(43) Pub. Date: Aug. 18, 2005

(54) Automotive telephone system

(76) Inventor: Manfred A. A. Lupke, Thornhill (CA)

Correspondence Address: DENNISON ASSOCIATES;SUITE 301, 133 RICHMOND ST. WEST, TORONTO, ON, M5H 2L7, CA

(21) Appl. No.: 10/778,055

(22) Filed: Feb. 17, 2004

(51) Int. Cl. H04J 3/17

(52) U.S. Cl. 455/575.9

(57) ABSTRACT

An automotive telephone system includes a phone assembly with a handset removable from a base unit permanently fixed within an automobile. The system further includes a headset with a speaker located remotely of the base unit. A switch provided which switches incoming telephone calls from the handset to the headset of the system.

### FIELD OF THE INVENTION

The present invention relates to an automotive telephone system.

### BACKGROUND OF THE INVENTION

Mobile telephones are becoming more and more popular. They have particular application for use in automobiles. Some mobile telephone systems are not strictly dedicated to automotive use. On the other hand, there are presently in the marketplace many telephone systems which are specifically designed for use in an automobile. These systems include a handset which is typically connected by a handset cord to a base unit permanently mounted within the automobile. The base unit, which provides a resting area for the handset is generally positioned in the console region of the automobile.

These automotive dedicated telephone systems as described immediately above can be difficult to use. The handset because of its corded connection to the base unit can be difficult to maneuver. Furthermore, it is usually relatively large and heavy.

As an assist to avoid having to use the handset these telephone systems also include a hands-free mode of operation. In the hands-free mode the handset is placed on the base unit and an incoming telephone call then goes through a speaker to the person taking the call. The base unit also has a receiver so that the person taking the call can respond in a hands-free mode to the person making the call.

The hands-free mode of operation as described immediately above suffers from the drawback that there is no privacy with respect to the conversation between the person taking the call in the car and the person making the call to the car. This can be a problem if there is confidential material to be discussed and if there is a passenger riding with the driver of the automobile.

Even in view of lack of privacy issue noted immediately above the hands-free mode of operation for existing automotive dedicated telephone systems is going to be the only way that they can be used in the future. For safety purposes, legislation is now being put into effect that requires hands-free use of automobile telephone systems.

### SUMMARY OF THE PRESENT INVENTION

The present invention provides an automotive telephone system which enables telephone systems of the type having a fixed base unit and an associated handset to be used in a hands-free mode without losing the privacy of a telephone conversation on the telephone system.

More particularly, the present invention provides an automotive telephone system comprising of telephone assembly including a handset removable from a base unit permanently fixed within the telephone system. Also included is a headset with a speaker and a transmitter provided at the headset. The headset is located remotely of the base unit. A switch is provided which switches incoming telephone calls from the handset to the headset of the system. The switch also allows the headset to be used when making outgoing calls.

According to a preferred aspect of the invention, the headset is secured by a flexible attachment member to a recoil device which provides automatic winding of the attachment member to pull the headset to a storage position. The flexible attachment member is also unwindable from the recoil device and lockable in different unwound positions when the headset is in use.

### BRIEF DESCRIPTION OF THE DRAWINGS

The above as well as other advantages and features of the present invention will be described in greater detail according to the preferred embodiments of the present invention in which;

FIG. 1 is a perspective view looking down on the interior of an automobile provided with an automotive telephone system according to a preferred embodiment of the present invention;

FIG. 2 is a schematic view showing the connection of the base unit to the headset recoil device of the system of FIG. 1;

FIG. 3 shows a switch for switching telephone calls from the base unit to the headset according to a preferred aspect of the invention as shown in FIG. 1 of the drawings;

FIG. 4 is a perspective view showing a recoil device for use in an automotive telephone system according to a further preferred embodiment of the present invention;

FIG. 5 is a perspective view looking down on the interior of an automobile with an automotive telephone system according to yet a further preferred embodiment of the invention;

FIG. 6 shows a wireless connection between the base unit and the headset of the system of FIG. 5 of the drawings; and

FIGS. 7 and 8 show another embodiment of the invention.

### DETAILED DESCRIPTION ACCORDING TO THE PREFERRED EMBODIMENTS OF THE PRESENT INVENTION IN WHICH

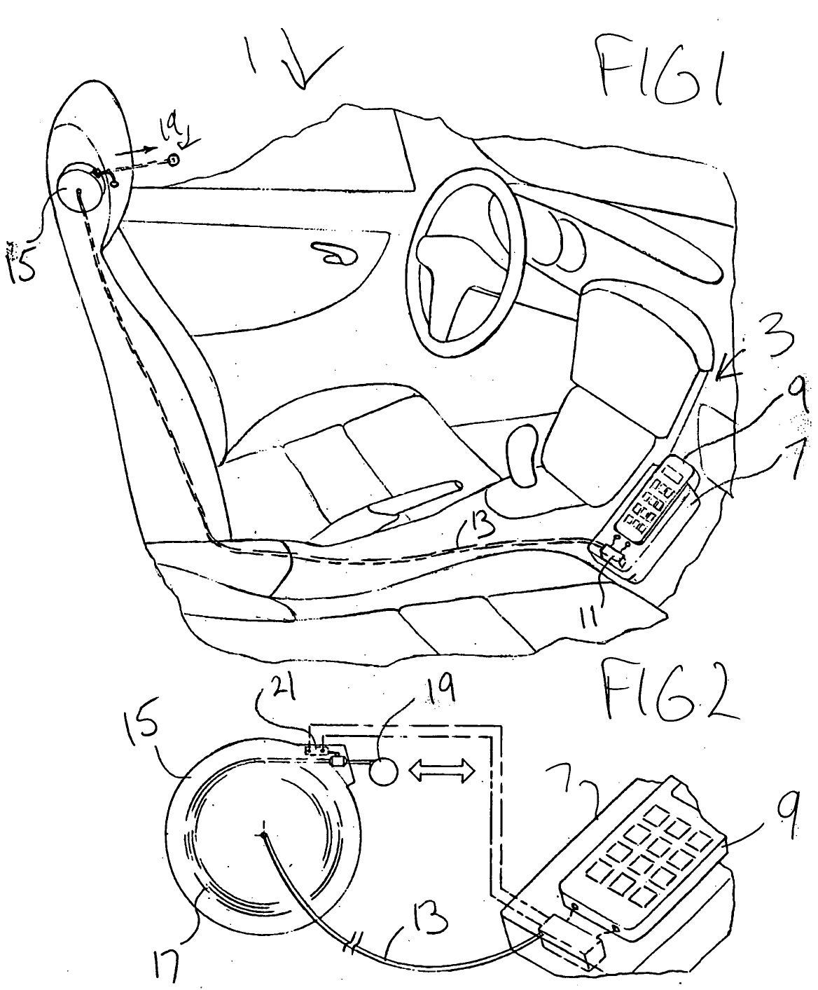

FIG. 1 shows the interior 1 of an automobile provided with a telephone system generally indicated at 3. This telephone system comprises a base unit 7 permanently secured within the console region of the automobile. A handset 9 sits on the base unit 7.

Although not shown in the drawings, in some automobiles the handset 9 is secured by a flexible cord to the base unit. In more up to date setups, the handset may be electronically linked without cord to the base unit.

The system thus far described is no different from what is presently available in the marketplace. According to known technology, incoming calls to the automobile are picked up by the base unit 7 and answered using some type of an incoming call button on the handset. The handset can then be picked up to be used in a conventional handheld telephone manner or it may be left on the base unit and the incoming call can be transferred through a speaker and receiver provided on either the base unit or the handset as a hands-free call.

If the handset is picked up for handheld use it quickly becomes relatively heavy in ones hand and necessitates one hand driving of the vehicle while the vehicle is in motion. According to driving regulations currently being put into force this is becoming an illegal method of driving the automobile because of the loss of vehicle control and distraction resulting from the use of the handset.

When the telephone call is not taken by using the handset but rather is taken using the remote speaker and transmitter feature as described above, other negative forces come into effect. Usually, there are extraneous noises within the automobile making it difficult to hear from both ends of the conversation. Furthermore, if there is a passenger riding with the driver of the vehicle the conversation is no longer private which is of particular concern when the incoming call provides anything in the way of confidential information. This confidential information is then undesirably heard by the vehicle passenger.

In accordance with the present invention telephone system 3 can be taken not only in the above two manners but also in a third manner unknown to the prior art and unique to the present invention. More specifically, in addition to the normal handheld use of handset 9, the remote use of the handset and base unit, the present invention also provides a headset use of telephone system 3.

The headset use of the telephone system as shown in FIGS. 1 and 2 of the drawings is provided by means of a headset piece 19. This headset piece comprises an ear-mount with its own miniature speaker and transmitter. The speaker which locates directly in the ear of the person taking the call does not allow the call to be heard other than by that particular person. The person using the headset can then guard his or her words if the call is of a confidential nature.

The operation of headset 19 as provided in the FIG. 1 embodiment is by means of wiring 13 which connects to the input 11 of the base unit 7. It is this input which directs the call either to the base unit or to the headset piece of the system. The system includes a switch having different switch positions to dictate where the call is taken.

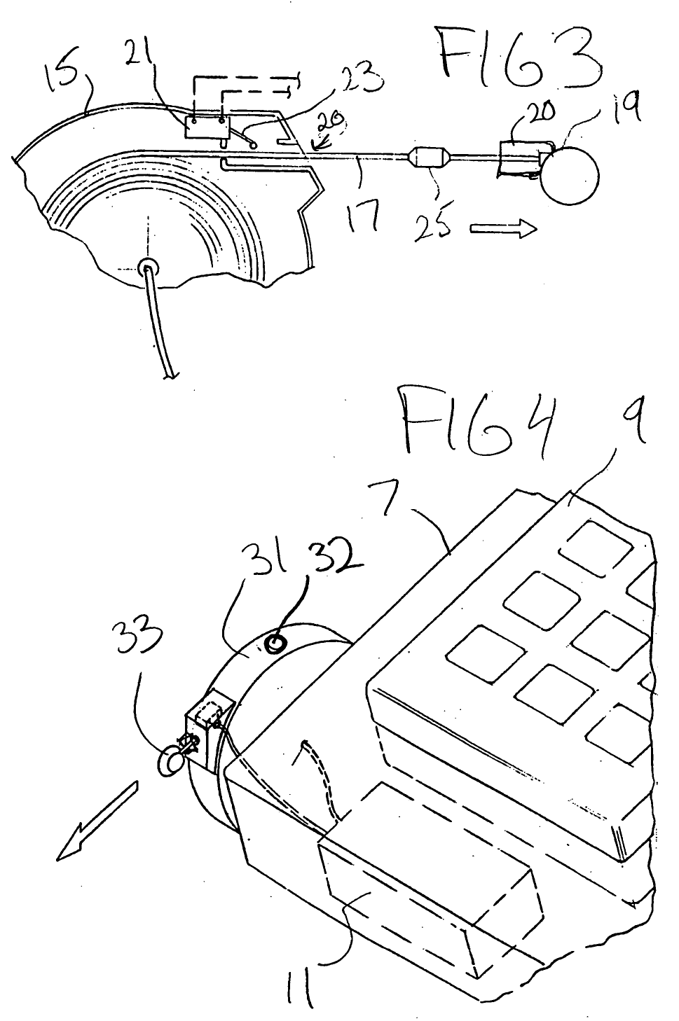

Wiring 13 is preferably hidden beneath the automotive upholstery and runs along both the console and up the side of the driver seat of the automobile. Provided at the upper end of the driver seat e.g., on the side of the headrest is a recoil device 15. A spool of wire 17 is located within recoil device 15. Wiring 13 feeding from the base unit penetrates into the recoil device and electrically connects with the wiring 17 on the spool inside the recoil device. Wiring 17 then connects directly to the headset 19. In the embodiment shown in FIGS. 1 through 3 of the drawings and as best seen in FIG. 3 the switch for determining where the call will be taken is indicated at 21 and is provided at the recoil device 15. This switch is operated by movement of headset 19.

More specifically, the wiring 17 to headset 19 exits recoil device 15 through a mouth region 20 of the recoil device. Switch 21 include a switch arm 23. A bulb 25 is provided on wiring 17 behind the headset 19.

When the call is first received by the telephone system it will generally be answered by the driver pushing the incoming call button provided on either the base unit or the handset. At this point the driver of the automobile has the option of using the telephone in any one of its three modes of operation. If it is determined that the call should be taken by the headset, the driver of the automobile will then pull the headset from its normally stored position as shown in solid lines in FIG. 1 outwardly to a use position shown in dotted lines in FIG. 1. The use position is also shown in FIG. 3 of the drawings. As is known for example in the window blind industry, the recoil device includes a recoil lock which will allow the headset to be pulled out to its use position and to then lock in that use position. A quick tug on the headset will cause the recoil device to unlock and automatically rewind the headset back to its storage position.

When the head piece is in its storage position bulb 25 locates to the left of switch 21. Switch arm 23 which is pivotal between an up position shown in FIG. 3 and a down position seats in its down position when the headset is in its stored position. When switch 23 is in its down position the headset is not in operation and the call is taken from either the base unit or the handset of the system.

By pulling the headset to its use position where the speaker of the headset is located in the driver's ear bulb 25 is pulled to the left in FIG. 3 past switch arm 23. This forces switch arm 23 to its up position as shown in FIG. 3. The movement of switch arm 23 to this up position automatically switches the call to the headset.

When the headset is recoiled back to its storage position bulb 25 clears past switch arm 23 in its up position. This relocates the bulb to the left of the switch. At the same time the trailing arm 20 which is provided on the headset and which is of larger diameter than bulb 25 impacts with switch 23. This forces the switch back to its down position turning the headset off. The headset is now stored and ready for further switching operation with the next incoming call.

In the immediately above described embodiment, the headset is in a particularly useful position very close to the head of the driver of the vehicle. Furthermore, other than the recoil device and the actual headset the extension of the telephone system to the headset i.e., wiring 13 is completely hidden by the vehicle upholstery.

In some cases it may not be easy to mount the recoil device with the headset in the location as described above. FIG. 4 shows an alternate embodiment of the invention in which a recoil device 31 identical in all aspects to recoil device 15 with exception to its location is mounted directly to the base unit of the telephone. Headset 33 then pulls out of recoil device 31 from the console area to the person using the headset.

In both of the above embodiments the switch to switch the call from the base unit to the headset is provided at and automatically operated by the headset. In the alternative the switch can be provided directly at the base unit or the handset. In either of these cases the switch is nothing more than a push button as indicated at 10 and 10a in FIG. 6.

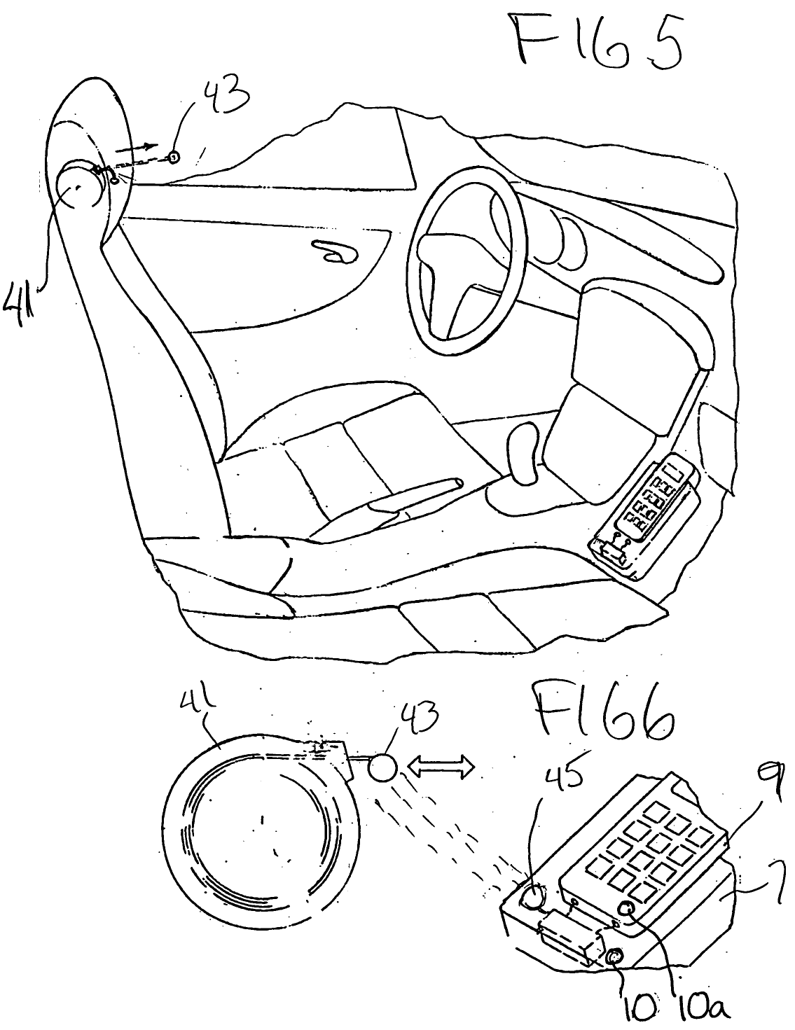

FIGS. 5 and 6 show a further preferred embodiment of the present invention. In this embodiment the recoil device 41 for the headset 43 is once again mounted at the headrest of the driver's seat. However, the recoil device is not hardwired back to the base unit 7 for the handset 9. Instead, a radio wave transmitter 45 is provided at base unit 7 and upon pulling of the headset to a use position the internal switch within recoil device switches on transmitter 45. This diverts the call from either the base unit or the handset and causes the transmission of radio waves directed upwardly towards headset 43. The speaker of the headset picks up these radio waves and the call remains private to the person wearing the headset.

When working with the radio wave transmission as described immediately above and in order for the person using the headset to speak back or to place an outgoing call the base unit of the system will still be used. The base unit is switched to a hands-free mode which allows the person inside the automobile, wearing the headset, back to talk back to the person on the other end of the call. However, as earlier described the speaker or receiver part of the system is not audible to anyone other than the person using headset 43.

In the description above the recoil system operates based on a quick tug or jerk of the headset to wind the headset flexible wire or other attachment into the recoil device. As a further alternative as shown in FIG. 4 a separate button 32 is provided on the recoil device for the rewind feature. The headset is pulled out and the attachment cord locks is position. A recoil spring provided in the recoil device is wound under tension. Pressing of button 32 releases the spring to pull the cord attachment back into the recoil device.

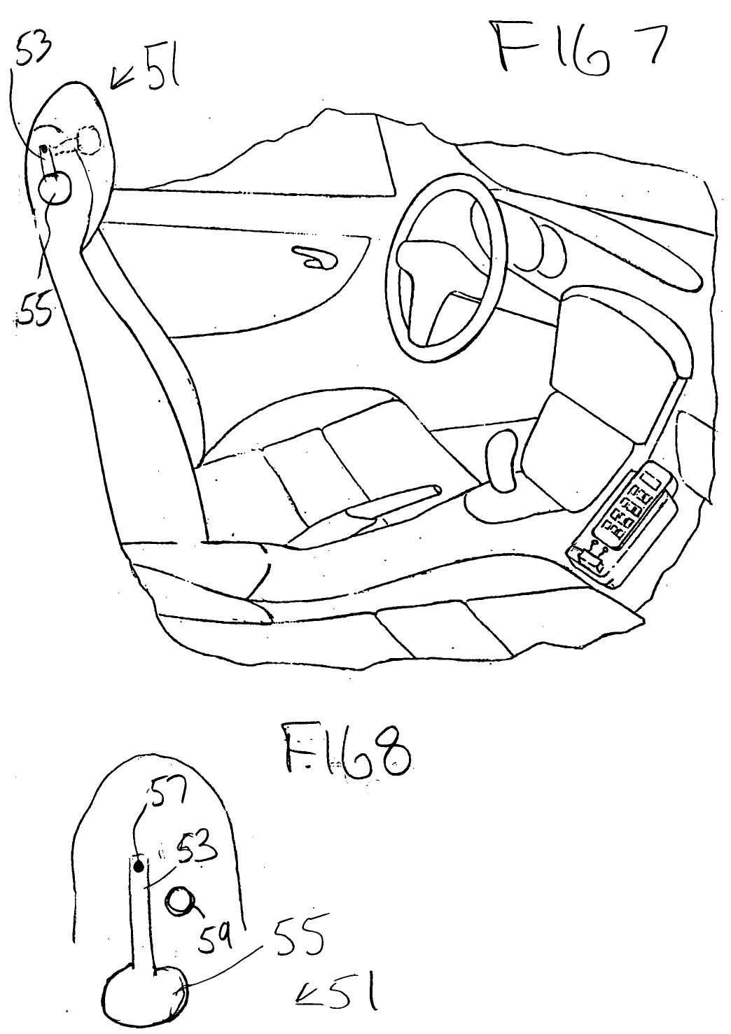

FIGS. 7 and 8 show another embodiment of the invention in which the recoil headset is replaced by another type of moveable headset. More specifically, the automotive telephone system includes a headset generally indicated at 51. This includes an arm 53 which is pivotally mounted at 57 to the headset of the automobile. An earpiece 55 is supported at the end of arm 53. In some cases the arm and earpiece are wired through the automobile upholstery back to the base unit of the phone system. In these cases, the headset includes a built in transmitter for both listening and speaking functions directly at the headset. In other instances the base unit of the phone system includes a radio wave transmitter to feed signal to the headset. In this setup the base unit of the phone will be used as the voice transmitter back to the person on the other end of the call.

When a call comes in on the system shown in FIGS. 7 and 8 it can be taken at either the handset or as a hands free call using the base unit of the system. As a further alternative the headset can be swung upwardly from the solid line storage position of FIG. 7 and of FIG. 8 to the dotted line use position of FIG. 7. As the arm 53 is being swung it contacts a switch 59 which automatically switches the call to the private earpiece 55. When the call is finished the headset is swung back down to its storage position. This pushes switch 59 back to a position in which the next incoming call is received at the base unit of the phone.

If desired the headset can be left in its use position in which case the next incoming call is taken directly at the headset.

It is to be understood that the switch for transferring the call to the headset in the FIG. 7 embodiment could be at the handset or at the base unit rather than at the headset as described above.

Although various preferred embodiments of the present invention have been described in detail, it will be appreciated by those skilled in the art that variations may be made without departing from the spirit of the invention or the scope of the appended claims.

1. An automotive telephone system comprising a telephone assembly including a handset removable from a base unit permanently fixed within the system, a headset including a speaker located remotely of said base unit and a switch which switches incoming telephone calls from said handset to said headset of said system.

2. An automotive telephone system as claimed in claim 1 wherein said headset is secured by a flexible attachment member to a recoil device which provides automatic winding of the attachment member to pull said headset to a storage position, said flexible attachment member being unwindable from said recoil device and lockable in different unwound positions when said headset is in use.

3. An automotive telephone system as claimed in claim 1 wherein said headset connected by wiring to said base unit and further includes a transmitter at said headset.

4. An automotive telephone system as claimed in claim 1 wherein said base unit transmits radio waves to said headset upon activation of said switch to switch the incoming calls from said handset to said headset.

5. An automotive telephone system as claimed in claim 1 wherein said switch is located at said handset.

6. An automotive telephone system as claimed in claim 1 wherein said switch is located at said base unit of said system.

7. An automotive telephone system as claimed in claim 2 wherein said switch operated by unwinding of said flexible attachment member at said recoil device.

8. An automotive telephone system as claimed in claim 7 wherein said switch is located at said recoil device and is operated by contact with said flexible attachment member as said flexible attachment member is unwound from said recoil device.

9. An automotive telephone system as claimed in claim 3 wherein said flexible attachment comprises electronic wiring which is length adjustably electronically connected to the wiring from said base unit to said headset.

10. An automobile with included telephone system, said telephone system comprising a combination and handset and a base unit, the base unit being fixed within said automobile, the handset being removable from the base unit, said telephone system further including a headset with a speaker located remotely of said base unit in said automobile and a switch which switches incoming telephone calls from said combination base unit and handset to said headset.

11. An automobile with included telephone system as claimed in claim 10 wherein said headset is secured by a flexible attachment member to a recoil device which provides automatic winding of the attachment member to pull said headset to a storage position, said flexible attachment member being unwindable from said recoil device and lockable in different unwound positions when said headset is in use.

12. An automobile with included telephone system as claimed in claim 10 wherein said automobile includes a driver's seat, said base unit of said system being connected by wiring to said headset through said driver's seat, said recoil device being located in an upper region of said driver's seat, said flexible attachment member comprising part of said wiring from said base unit to said headset.

13. An automobile with included telephone system as claimed in claim 10 wherein said automobile includes a driver's seat, said recoil device being located in an upper region of said driver's seat, said base unit transmitting radio waves to said headset upon activation of said switch to switch the incoming calls from said handset to the headset.

14. An automobile with included telephone system as claimed in claim 10 wherein said headset includes an earpiece which is moveably secured to an upper region of a driver seat in said automobile.

15. An automobile with included telephone system as claimed in claim 14 wherein said earpiece is moveable between a storage position and a use position, said system including a switch which switches incoming telephone calls to said headset when said earpiece is moved from the storage position to the use position.

16. An automobile with included telephone system as claimed in claim 14 wherein said headset includes a support arm for said earpiece, said support arm being pivotally mounted to said driver seat for swinging said earpiece between use and storage positions.
